(19) United States
(12) Patent Application Publication
(10) Pub. No.: US 2014/0276277 A1
(43) Pub. Date: Sep. 18, 2014

(54) Foot Massager

(71) Applicant: Jue-Yao Chen, Erlin Township (TW)

(72) Inventor: Jue-Yao Chen, Erlin Township (TW)

(21) Appl. No.: 13/804,134

(22) Filed: Mar. 14, 2013

(51) Int. Cl. A61H 15/00

(52) U.S. Cl. CPC A61H 15/0078
USPC 601/112

(57) ABSTRACT

A foot massager includes a plurality of roller massagers, two rotational massagers, a power source, a forward-and-backward-movable device, a first transmission device, and a second transmission device. The power source rotates clockwise and drives the first transmission device and the second transmission device, such that the first transmission device drives a one-way bearing to perform idle rotation and drives the roller massagers to perform rolling massage, whereas the second transmission device drives the two rotational massagers to perform rotational massage. The power source rotates anticlockwise and drives the first transmission device and the second transmission device, such that the first transmission device drives the one-way bearing to drive the foot massaging base to move forward and backward in its entirety and drives the roller massagers to perform rolling massage, whereas the second transmission device drives the two rotational massagers to perform rotational massage.

### BACKGROUND OF THE INVENTION

1. Technical Field

The present invention relates to massagers, and more particularly, to a foot massager comprising a plurality of roller massagers and two rotational massagers, adapted to massage the human foot, or moving forward and backward to perform rolling massage and rotational massage on the foot simultaneously.

2. Description of Related Art

An important organ of the human body, the human feet enable a human being to walk and run. The elderly who have been leading an athletic lifestyle for decades are able to have a brisk walk. A pair of strongly-built feet is not only prerequisite to global travel but also effective in preventing a misplaced step; it serves every human being every day and thus deserves good maintenance—to this end, conventional foot massagers are in wide use.

The conventional foot massagers are designed to perform rolling massage only and thus are monotonous in terms of massage styles, manifest finite efficacy, and fail to relieve foot fatigue effectively. Accordingly, there is still room for improvement in the conventional foot massagers.

### SUMMARY OF THE INVENTION

It is an objective of the present invention to provide a foot massager. The foot massager has therein a foot massaging base capable of moving forward and backward. The foot massaging base has therein a plurality of roller massagers and two rotational massagers. A power source drives the plurality of roller massagers and two rotational massagers to massage the sole of the foot, drives the foot massaging base to move forward and backward in its entirety, and drives the plurality of roller massagers and two rotational massagers to massage the sole of the foot.

In order to achieve the above and other objectives, the present invention provides a foot massager, comprising: a plurality of roller massagers, two rotational massagers, a power source, a forward-and-backward-movable device, a first transmission device, and a second transmission device. The power source is a two-axis motor. The two-axis motor rotates clockwise and drives the first transmission device and the second transmission device simultaneously. The first transmission device drives a one-way bearing to perform idle rotation and drives the plurality of roller massagers to perform rolling massage. The second transmission device drives the two rotational massagers to perform rotational massage. The two-axis motor rotates anticlockwise and drives the first transmission device and the second transmission device simultaneously. The first transmission device drives the one-way bearing to drive the foot massaging base to move forward and backward in its entirety and drives the plurality of roller massagers to perform rolling massage. The second transmission device drives the two rotational massagers to perform rotational massage.

### BRIEF DESCRIPTION OF THE DRAWINGS

FIG. 1 is a perspective view of a massager base and a foot massaging base therein of a foot massager according to an embodiment of the present invention;

FIG. 2 is an exploded view of the massager base and the foot massaging base according to an embodiment of the present invention;

FIG. 3 is an exploded view of the foot massaging base according to an embodiment of the present invention;

FIG. 4 is an exploded view of a roller massager and a rotational massager according to the present invention;

FIG. 5 is a perspective view of a first and second transmission device viewed from below according to the present invention;

FIG. 6 is a cross-sectional view of the foot massager according to a preferred embodiment of the present invention; and

FIG. 7 is a top view of operation of the foot massager according to an embodiment of the present invention.

### DETAILED DESCRIPTION OF THE EMBODIMENTS OF THE INVENTION

Referring to FIG. 1 through FIG. 7, the present invention provides a foot massager comprising a massager base 10, a foot massaging base 20, a power source 30, a plurality of roller massagers 40, two rotational massagers 50, a first transmission device 60, a second transmission device 70, and a forward-and-backward-movable device 80.

The massager base 10 is rectangular frame-like and has an opening 11 that opens upward. The massager base 10 has therein a sliding recess 12 for use in forward and backward movement. A plurality of massage protrusions 13 is protrudingly disposed on the top surface of the massager base 10, such that the sole of the foot treading the top surface of the massager base 10 is massaged by the plurality of massage protrusions 13.

The foot massaging base 20 is disposed inside the sliding recess 12.

The power source 30 is disposed inside the foot massaging base 20. The power source 30 is a two-axis motor 31. The two-axis motor 31 has a first driving worm 311 and a second driving worm 312.

The plurality of roller massagers 40 is pivotally disposed on the top surface of the foot massaging base 20. The plurality of roller massagers 40 has a plurality of shaft portions 41. Every two adjacent shaft portions 41 are connected and thus power-driven by means of a timing belt 42 and two pulleys 43. The shaft portions 41 each having a plurality of massage wheels 44 fixed thereto. A bevel gear 45 is penetratingly disposed at the outermost shaft portion 41 and thus fixed thereto.

The two rotational massagers 50 are protrudingly disposed on the top surface of the foot massaging base 20. A gear 51 is disposed at the bottom of each of the two rotational massagers 50 and penetratingly disposed inside the foot massaging base 20. A plurality of massage heads 52 is protrudingly disposed on the top surface of the rotational massagers 50. The rotational massagers 50 each have therein an infrared lamp plate 53 for performing heat treatment-oriented massage.

The first transmission device 60 is disposed inside the foot massaging base 20 and comprises a first and second gears 61, 62 which are integrally formed as a unitary structure. The first gear 61 meshes with the first driving worm 311. A third gear 63 and a fourth bevel gear 64 are integrally formed as a unitary structure. The third gear 63 meshes with the second gear 62. The fourth bevel gear 64 meshes with the bevel gear 45 to thereby drive the roller massagers 40 to rotate. The first transmission device 61 comprises a fifth gear 65 which meshes with the first driving worm 311. The fifth gear 65 has therein a one-way bearing 651. The one-way bearing 651 ensures that the two-axis motor 31 can rotate in one direction to drive only if the two-axis motor 31 rotates in the other direction to perform idle rotation. A sixth gear 66 is coaxially and fixedly disposed at the one-way bearing 651. The sixth gear 66 meshes with a seventh gear 67 to drive an eighth gear 68 and a ninth bevel gear 69 which are integrally formed as a unitary structure. The eighth gear 68 meshes with the seventh gear 67.

The second transmission device 70 is disposed inside the foot massaging base 20. The second transmission device 70 comprises two tenth gears 71 which mesh with the second driving worm 312. Each of the two tenth gears 71 and an eleventh gear 72 are integrally formed as a unitary structure. The two eleventh gears 72 mesh with the two gears 51 of the two rotational massagers 50, respectively.

The forward-and-backward-movable device 80 is disposed inside the foot massaging base 20. The forward-and-backward-movable device 80 comprises a rod 81 having a guide groove 811. The rod 81 is pivotally disposed on the foot massaging base 20. A bevel gear 82 is fixed to one end of the rod 81 to mesh with the ninth bevel gear 69. A fixing base 83 is fixed to the massager base 10. A guide bump 831 disposed on the fixing base 83 is engaged with and disposed in the guide groove 811 of the rod 81, such that the rod 81 rotates and drives the foot massaging base 20 to move forward and backward in its entirety.

The two-axis motor 31 rotates clockwise and drives the first transmission device 60 and the second transmission device 70 simultaneously. The first transmission device 60 drives the one-way bearing 651 to perform idle rotation and drives the plurality of roller massagers 40 to perform rolling massage. The second transmission device 70 drives the two rotational massagers 50 to perform rotational massage. The two-axis motor 31 rotates anticlockwise and drives the first transmission device 60 and the second transmission device 70 simultaneously. The first transmission device 60 drives the one-way bearing 651 to drive the foot massaging base 20 to move forward and backward in its entirety and drives the plurality of roller massagers 40 to perform rolling massage that involves forward and backward movement. The second transmission device 70 drives the two rotational massagers 50 to perform rotational massage that involves forward and backward movement.

As regards the foot massager, a lid 21 is disposed on the foot massaging base 20 above the two-axis motor 31, and a plurality of massage protrusions 211 is protrudingly disposed on the top surface of the lid 21. Hence, the sole of the foot treading on the lid 21 is massaged by the plurality of massage protrusions 211.

Referring to FIG. 1 through FIG. 7, given the aforesaid combination of the constituent elements of the foot massager, the foot massager offers two choices pertaining to massage styles, namely “performing rolling massage and rotational massage simultaneously”, and “performing rolling massage that involves forward and backward movement and rotational massage that involves forward and backward movement simultaneously”. To this end, the foot massager is characterized in that the two-axis motor 31 rotates clockwise or anticlockwise such that the clockwise or anticlockwise rotation of the two-axis motor 31 drives the one-way bearing 651 to perform idle rotation or drives the forward-and-backward-movable device 80 to drive the foot massaging base 20 to move forward and backward in its entirety. The two-axis motor 31 rotates clockwise and drives the first transmission device 60 and the second transmission device 70 to rotate simultaneously, such that the first transmission device 60 drives the one-way bearing 651 to perform idle rotation and drives the plurality of roller massagers 40 to perform rolling massage, whereas the second transmission device 70 drives the two rotational massagers 50 to perform rotational massage. The two-axis motor 31 rotates anticlockwise and drives the first transmission device 60 and the second transmission device 70 to rotate simultaneously, such that the first transmission device 60 drives the one-way bearing 651 to drive the foot massaging base 20 to move forward and backward in its entirety and drives the plurality of roller massagers 40 to perform rolling massage that involves forward and backward movement, whereas the second transmission device 70 drives the two rotational massagers 50 to perform rotational massage that involves forward and backward movement. Accordingly, the foot massager of the present invention massages and alleviates the stress of the muscles of the feet to thereby relieve foot fatigue effectively.

What is claimed is:

1. A foot massager, comprising:
a massager base being rectangular frame-like, having an opening upward, and having therein a sliding recess for use in forward and backward movement;
a foot massaging base disposed inside the sliding recess;
a power source disposed inside the foot massaging base and being a two-axis motor having a first driving worm and a second driving worm;
a plurality of roller massagers pivotally disposed on a top surface of the foot massaging base and having a plurality of shaft portions, every two adjacent shaft portions being connected and thus power-driven by means of a timing belt and two pulleys, the shaft portions each having a plurality of massage wheels fixed thereto, wherein a bevel gear is penetratingly disposed at the outermost shaft portion and fixed thereto;
two rotational massagers protrudingly disposed on the top surface of the foot massaging base, wherein a gear is disposed at a bottom of each of the two rotational massagers and penetratingly disposed inside the foot massaging base, wherein a plurality of massage heads is protrudingly disposed on a top surface of the rotational massagers;
a first transmission device disposed inside the foot massaging base and comprising a first and second gears integrally formed as a unitary structure, the first gear meshing with the first driving worm, wherein a third gear and a fourth bevel gear are integrally formed as a unitary structure, the third gear meshing with the second gear, the fourth bevel gear meshing with the bevel gear to thereby drive the roller massagers to rotate, the first transmission device further comprising a fifth gear meshing with the first driving worm and having therein a one-way bearing, wherein the one-way bearing ensures that the two-axis motor can rotate in one direction to drive only if the two-axis motor rotates in the other direction to perform idle rotation, wherein a sixth gear is coaxially and fixedly disposed at the one-way bearing and meshes with a seventh gear, the seventh gear meshing with an eighth gear, the eighth gear being integrally formed with a ninth bevel gear;
a second transmission device disposed inside the foot massaging base and comprising two tenth gears each meshing with the second driving worm, the two tenth gears each being integrally formed with an eleventh gear, the two eleventh gears meshing with the two gears of the two rotational massagers, respectively; and
a forward-and-backward-movable device disposed inside the foot massaging base and comprising a rod having a guide groove, the rod being pivotally disposed on the foot massaging base, wherein a bevel gear is fixedly disposed at an end of the rod to mesh with the ninth bevel gear, wherein a fixing base is fixed to the massager base, and a guide bump disposed on the fixing base is engaged with and disposed in the guide groove of the rod, such that the rod rotates and drives the foot massaging base to move forward and backward in its entirety, wherein the two-axis motor rotates clockwise and drives the first transmission device and the second transmission device simultaneously, such that the first transmission device drives the one-way bearing to perform idle rotation and drives the plurality of roller massagers to perform rolling massage, whereas the second transmission device drives the two rotational massagers to perform rotational massage, wherein the two-axis motor rotates anticlockwise and drives the first transmission device and the second transmission device simultaneously, such that the first transmission device drives the one-way bearing to drive the foot massaging base to move forward and backward in its entirety and drives the plurality of roller massagers to perform rolling massage involving forward and backward movement, whereas the second transmission device drives the two rotational massagers to perform rotational massage involving forward and backward movement.

2. The foot massager of claim 1, wherein a plurality of massage protrusions is protrudingly disposed on a top surface of the massager base, such that a sole of a foot treading on the top surface of the massager base is massaged by the plurality of massage protrusions.

3. The foot massager of claim 1, wherein the rotational massagers each have therein an infrared lamp plate for performing heat treatment-oriented massage.

4. The foot massager of claim 1, wherein a lid is disposed on the foot massaging base above the two-axis motor, and a plurality of massage protrusions is protrudingly disposed on a top surface of the lid.
